(19) United States
(12) Patent Application Publication
(10) Pub. No.: US 2006/0151988 A1
(43) Pub. Date: Jul. 13, 2006

(54) Paper ring, printed material or calendar using such ring, and method for manufacture thereof

(75) Inventor: Kiyomu Asai, Takatsuka-shi (JP)

Correspondence Address: DARBY & DARBY P.C., P. O. BOX 5257, NEW YORK, NY, 10150-5257, US

(73) Assignee: Shinyo Engineering Limited, Takatsuki-shi (JP)

(21) Appl. No.: 11/035,569

(22) Filed: Jan. 13, 2005

(51) Int. Cl. B42D 5/04

(52) U.S. Cl. 283/2

(57) ABSTRACT

A paper ring which is made entirely from paper and, therefore, does not discharge toxic substances during waste treatment, a calendar or a printed material using such ring, and a method for manufacture thereof. A calendar comprising a paper ring which is impregnated at least with a sugar and in which the distal ends of protruding portions and the distal end of the opposing base portion in a cylindrical linking paper member of a comb-like shape in an expanded state are adhesively bonded, and a plurality of paper sheets provided at one end side thereof with through holes into which the protruding portions of said linking paper member are inserted and which can move, while being guided by said protruding portions, after adhesive bonding, wherein the plurality of paper sheets include one calendar cover sheet and a plurality of calendar body sheets.

### BACKGROUND OF THE INVENTION

1. Field of the Invention

The present invention relates to a paper ring containing absolutely no plastics or metals, a calendar or printed material using such a ring, and a method for manufacture thereof.

2. Description of Related Art

FIG. 9(a) is a plan view of a conventional calendar. The calendar is composed of a calendar cover 40 having a folded portion 40a, a calendar body 41 comprising 6 or 12 sheets, a holding member 42 engaged with the folded portion 40a for holding the calendar cover 40, and a ring-like linking member 43 inserted into the through holes 44 of the calendar cover 40 and calendar body 41 to bundle the entire structure. Here, both the holding member 42 and the linking member 43 are made from plastics.

In order to mount the ring-like linking member 43 on the calendar, first, an appropriate auxiliary member is used to expand the linking member 43 against the imparting force of the linking member 43 which is to be rounded (see an arrow in FIG. 10). Then, the calendar cover 40 and calendar body 41 are lowered on the linking member 43 in this state, the auxiliary member is then removed, the linking member 43 is inserted elastically into the through hole 44, and the linking member 43 is returned to its original ring-like shape.

Further, when the holding member 42 is mounted on the calendar, the folded portion 40a of the calendar cover 40 has to be engaged with the holding member 42. Therefore, as shown in FIG. 11(b), the holding member 42 is manually inserted into the calendar cover 40, and then the calendar cover 40 is pulled to the left, as shown in FIG. 11, thereby engaging the folded portion 40a with the holding member 42. Further, the calendar body 41 is successively torn off after being used, and the lower end portion thereof hangs on the holding member 42 and is held thereon (see FIG. 9(b)).

However, a problem associated with such a calendar is that it comprises plastic components and, therefore, cannot be easily burned. A specific feature of calendars is that they are generally discarded after 12 months in all the households on the earth. Therefore, it is very difficult to process them all in the incineration plants before the end of January, and incineration thereof could created environmental problems. Another problem associated with the conventional calendars was that they required manual operations, for example, as shown in FIGS. 11(b) and (c), production efficiency was poor, and therefore the production cost was high.

Furthermore, in self-composed works such as manuals that are produced in small quantities in industrial enterprises, inscriptions can be made, for example, with a pen on the front and rear covers, and none of such works allowed for simple and easy insertion of special pages.

The present invention was created to resolve the above-described problems and it is an object thereof to provide a paper ring that can be mechanically manufactured without manual operations and is composed entirely of paper. As a result, the discharge of toxic substances during waste treatment is eliminated and the ring is environmentally friendly. Another object is provide a calendar or printed material using such a ring, and a method for manufacture thereof.

### SUMMARY OF THE INVENTION

In order to attain the above-described objects the present invention provides a paper ring, which is a linking paper member of a comb-like shape impregnated at least with sugar and composed of protruding portions and a base portion in an expanded state, wherein this linking paper member is formed to have a cylindrical shape having a central axis defined by the direction parallel to the direction along which the comb teeth are arranged and the two end portions of the linking paper member are not adhesively joined.

Sugar is selected as a material for impregnating the linking paper member because it is inexpensive and facilitates handling during ring production or recycling. Furthermore, because the molecular structure thereof is close to that of pulp cellulose, it can easily permeate into paper and effectively reduces the material shrinkage ratio during drying, thereby providing for increased processing accuracy. Another advantage thereof is that it hardly changes its properties after the completion of production. In accordance with the present invention, sucrose is the preferred sugar because it is easy to purchase and handle. Furthermore, it is preferred that granular sugar with a high sucrose purity be used in order to demonstrate fully the aforementioned effect. In the linking paper member that retains a cylindrical shape, the distal ends of the protruding portion can overlap the distal end of the opposing base portion. However, from the standpoint of operability and operation time, it is preferred that the distal end of the protruding portion of the linking paper member is at a distance of not less than 1 mm and no more than 3 mm from the distal end of the opposing base portion. More specifically, if this distance is less than 1 mm, then the operation of inserting into a printed material or calendar is made difficult, and if the distance is more than 3 mm, a long time is required to bond adhesively the two end portions of the ring.

Furthermore, the present invention also provides a printed material comprising a paper ring which is impregnated at least with a sugar and in which the distal ends of protruding portions in a cylindrical linking paper member of a comb-like shape in an expanded state and the distal end of the opposing base portion are adhesively bonded and a plurality of paper sheets provided with through holes into which the protruding portions of the linking paper member are inserted and which can move while being guided by the protruding portions after adhesive bonding.

Here, the printed material is, for example, a self-composed printed material such as a manual produced in an industrial enterprise and a private printed material for individual use. Those printed materials are manufactured with a production apparatus for automatic realization of a process comprising the steps of inserting into the through holes and forming into a ring-like shape by adhesively bonding the end portions of the linking paper member. In such a production apparatus, only the linking paper member formed to have an almost C-like cross section is supplied as a material, thereby simplifying he present invention. Furthermore, it is preferred that a process of mechanically forming all the through holes may be provided prior to the process of insertion into the through holes. Moreover, the through holes may have a round or elliptical shape, but from the standpoint of facilitating the insertion operation, it is preferred that they have a rectangular shape.

Furthermore, the present invention also provides a calendar comprising a paper ring which is impregnated at least with a sugar and in which the distal ends of protruding portions in a cylindrical linking paper member of a comb-like shape in an expanded state and the distal end of the opposing base portion are adhesively bonded and a plurality of paper sheets provided at one end side thereof with through holes into which the protruding portions of the linking paper member are inserted and which can move while being guided by the protruding portions after adhesive bonding, wherein

the aforementioned plurality of paper sheets include one calendar cover sheet and a plurality of calendar body sheets.

Here, in the calendars, the calendar cover may also serve as a calendar body sheet. Furthermore, the term “calendars”, in addition to articles that are used only as calendars, also includes various multipurpose articles such as small containers in which a calendar closed with a paper ring is retained as a covering with the ring as an apex point.

Further, it is also preferred that a fixing paper member of a U-like cross-section be adhesively bonded on the other end side of the calendar cover, among a plurality of paper sheet, and that a gap capable of accommodating the lower end portion of calendar body sheet be formed between the fixing paper member and the calendar cover.

Furthermore, the present invention also provides a method for the manufacture of a paper ring by which a linking paper member of a comb-like shape composed of protruding portions and a base portion in an expanded state is impregnated at least with a sugar and then molding is conducted by drying, while retaining a cylindrical shape having a central axis defined by the direction parallel to the direction along which the comb teeth are arranged.

Further, the present invention also provides a method for the manufacture of a printed material, comprising the steps of: forming through holes on one end side of a plurality of paper sheets, impregnating at least with a sugar a linking paper member which has a comb-like shape composed of protruding portions and a base portion in an expanded state, then drying while retaining a cylindrical shape, having a central axis defined by the direction parallel to the direction along which the comb teeth are arranged, and thereafter inserting the protruding portions of the linking paper member into the through holes and then adhesively bonding the distal ends of the protruding portions and the distal ends of the opposing base portions in the linking paper member to form a cylindrical shape.

Further, the present invention also provides a method for the manufacture of a calendar, comprising the steps of: forming through holes on one end side of a plurality of paper sheets, impregnating at least with a sugar a linking paper member which has a comb-like shape composed of protruding portions and a base portion in an expanded state, then drying while retaining a cylindrical shape having a central axis defined by the direction parallel to the direction along which the comb teeth are arranged, and thereafter inserting the protruding portions of the linking paper member into the through holes and then adhesively bonding the distal ends of the protruding portions and the distal ends of the opposing base portions in the linking paper member to form a cylindrical shape.

Here, the operation of inserting into the through holes is preferably implemented by rotating the linking paper member along the guiding member with at least part thereof having a cylindrical shape.

### BRIEF DESCRIPTION OF THE DRAWINGS

FIG. 1(a) is a front view of the calendar of the first embodiment and (b) is an enlarged right-side view of the fixing paper member;

FIG. 2 illustrates adhesive bonding of the calendar cover and the fixing paper member;

FIG. 3 illustrates the expanded state of the linking paper member;

FIG. 4 explains the mounting method of the linking paper member;

FIG. 5 shows a state immediately prior to mounting the linking paper member on the calendar cover or calendar body;

FIG. 6 shows an auxiliary member causing the linking paper member to rotate;

FIG. 7 explains a method for placing an adhesive material on the linking paper member;

FIG. 8 is a front view of a manual of the second embodiment;

FIG. 9(a) is a front view of the conventional calendar and (b) a cross-sectional view in the center of the front view;

FIG. 10 illustrates the method for mounting the linking paper member on the calendar cover or calendar body;

FIG. 11 illustrates a method for mounting a holding member on the calendar cover;

FIG. 12 illustrates another method for placing an adhesive material on the linking paper member; and

FIG. 13 illustrates another method for mounting the linking paper member.

### DESCRIPTION OF THE PREFERRED EMBODIMENTS

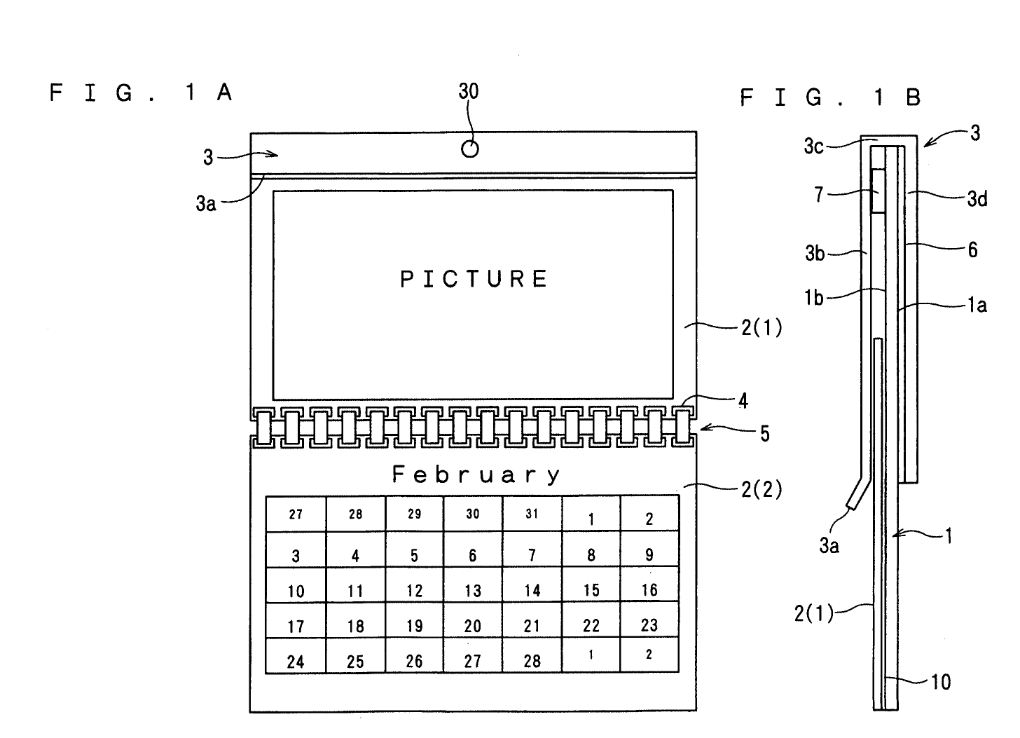

An embodiment of the present invention will be described below based on the working example thereof. FIG. 1 illustrates a working example in which the present invention was employed in a calendar. The calendar is composed of a calendar cover 1, a 12-sheet calendar body 2₍₁₎ to 2₍₁₂₎ representing one year by months, a fixing member 3 with a U-shaped cross-section, this fixing member being adhesively bonded to the calendar cover 1, and a linking paper member 5 inserted into rectangular holes 4 in the calendar cover 1 and calendar body 2 to bundle the entire structure.

The calendar of the present working example uses absolutely no metal or plastic materials and the entire calendar is made from paper. Therefore, not only the production cost is low, but also the calendar can be burned without environmental concerns. Furthermore, the fixing paper member 3 or linking paper member 5 can be effectively used as printing surfaces for commercial ads or industrial information. Furthermore, because no metal hooks are used, there is no risk of the user getting hurt when using the calendar.

Further, the rear surface 10 of the calendar cover 1 is the image surface for the calendar body 2₍₁₎ for January and a photo or painting relating to January is placed thereon. Similarly, the rear surface of the calendar body 2_{(N)} of the N-th month is the image surface for the calendar body 2_{(N+1)} for the (N+1)-th month and a photo or painting relating to (N+1)-th month is placed thereon. When a transition is made from the N-th month to the (N+1)-th month, the calendar body 2_{(N)} of the N-th month is torn off and the lower end portion thereof is clamped and held in the fixing paper member 3.

In the fixing member 3, through holes 30 for hanging the calendar in the central portion thereof are provided through the calendar cover 1. More specifically, the fixing paper member 3 is composed of a front lower end portion 3a, a local adhesive bonding portion 3b, a folded portion 3c, and a full-surface adhesive bonding portion 3d (see FIG. 1(b)), and the U-shaped cross section is formed by folding in the folded portion 3c. The full-surface adhesive bonding portion 3d serves to bond adhesively the fixing paper member 3 and the upper portion 1a of the front surface of the calendar cover 1 over the entire surface. On the other hand, the local adhesive bonding portion 3b is designed for local adhesive bonding of the upper portion 1b of the rear surface of the calendar cover 1 and the fixing paper member 3 with an adhesive material 7 placed on the upper portion 1b of the rear surface of the calendar cover 1. Here, the full-surface adhesive bonding portion 3d and local adhesive bonding portion 3b are formed to almost the same length.

The lower end portion of the highest November calendar body 2 (January to November) can be accommodated in a gap formed between the fixing paper member 3 and the rear surface 10 of the calendar cover 1 by establishing the prescribed height with the adhesive bonding portion 7 and appropriately bending and expanding the fixing paper member 3 (more specifically the local adhesive bonding portion 3b). In this case, because the full-surface adhesive bonding portion 3d and local adhesive bonding portion 3b have almost the same length, the lower end portion of the accommodated calendar body 2 can be held reliably.

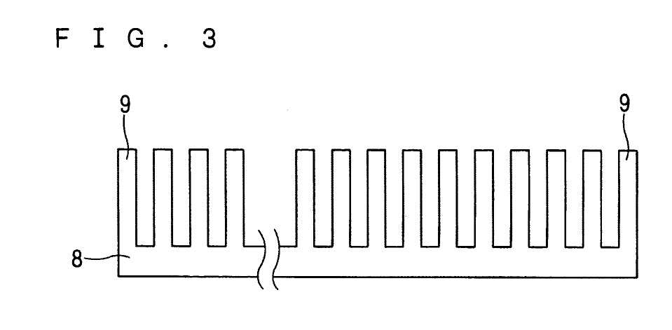

As shown in FIG. 3, the linking paper member 5 is composed of a paper material formed to have a comb-like shape comprising a base portion 8 and protruding portions 9. More specifically, the linking paper member 5 is composed by bending the entire member into a ring-like shape, inserting the protruding portions 9 into the through holes 4 of the calendar body 2, and then adhesively bonding the distal ends of the protruding portions 9 to part of the base portion 8. For this purpose, an appropriate paper material (for example, white-sheet paper or color-sheet paper) with a thickness of about 1 mm or less is selected so as to prevent rupture when the calendar is used and facilitate curling when the linking paper member is curved. Further, the thickness of the paper can be further reduced by appropriately selecting the paper material or sugar for impregnation. Further, if an easily printable paper material is selected, then the protruding portions 9 can be used as the printing surfaces. For example, the telephone number of the calendar supplier can be printed therein.

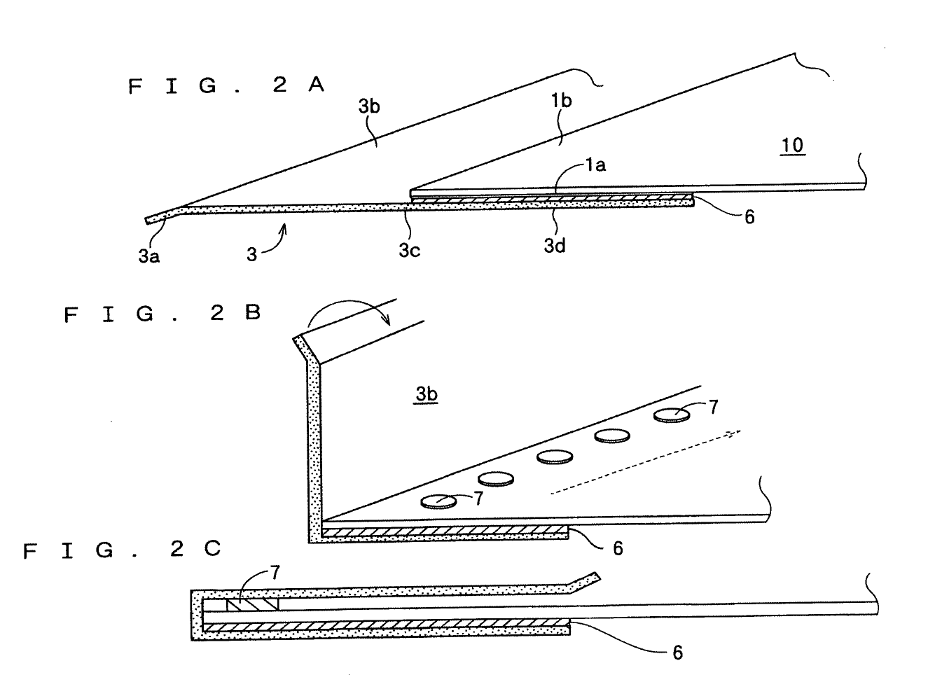

A method for the manufacture of the calendar of the working example will be explained below. First, adhesive bonding of the calendar cover 1 and fixing paper member 3 will be described with reference to FIG. 2. The fixing paper member 3 is expanded in a state in which a curl is provided to the front lower end portion 3a and folded portion 3c, and the adhesive material 6 is applied over the entire surface of the full-surface adhesive portion 3d. Then, the upper portion 1a of the front surface of the calendar cover 1 is placed on the full-surface adhesive portion 3d and adhesively bonded thereto (FIG. 2(a)). Further, the rear surface 1b of the calendar cover 1 is the image surface for January, as described hereinabove.

Then, the adhesive material 7 is intermittently disposed on the upper portion 1b of the front surface of the calendar cover 1. The intermittent disposition is not the only possible one, and the adhesive material may be also disposed along a line in the width direction of the calendar. Further, no specific limitation is placed on the adhesive material, but an adhesive material of a hot-melt type is preferably used. The fixing paper member 3 is folded in the folded portion 3c before the adhesive material 7 is cured, and the local adhesive bonding portion 3b is pressed against the calendar cover 1 to integrate them together.

Then, a through hole 30 for hanging the calendar is formed. Because all the operations are implemented mechanically, the production efficiency is good since no manual operations, as in the conventional processes, are required. It goes without saying, that even if manual operations are used, they are not difficult. Once the above-describe operations have been completed, the calendar cover 1 and calendar body 2 are laminated and a plurality of rectangular holes 4 are formed together in the prescribed positions. Further, the number of rectangular holes 4 is equal to the number of the protruding portions 9 of the linking paper member 5. It goes without saying that the size of the through holes should be sufficient to insert the protruding portions 9 of the linking paper member 5 and such as to enable the movement along the protruding portions 9 as guides after the adhesive bonding.

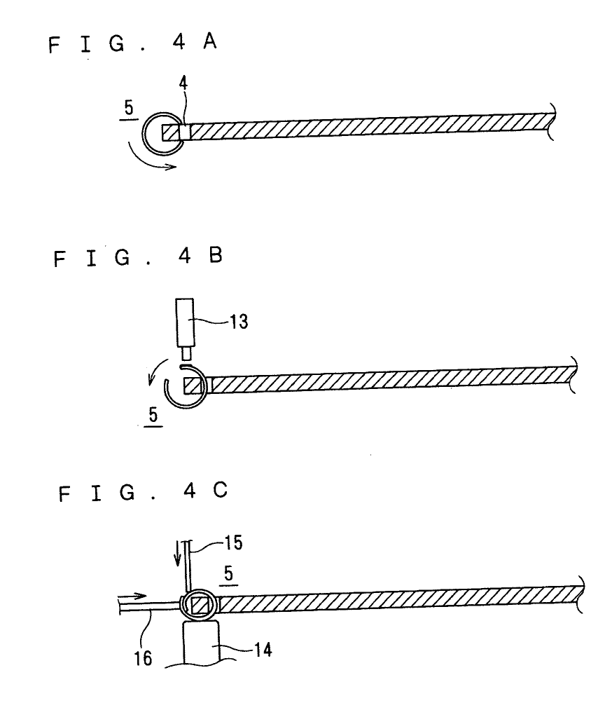

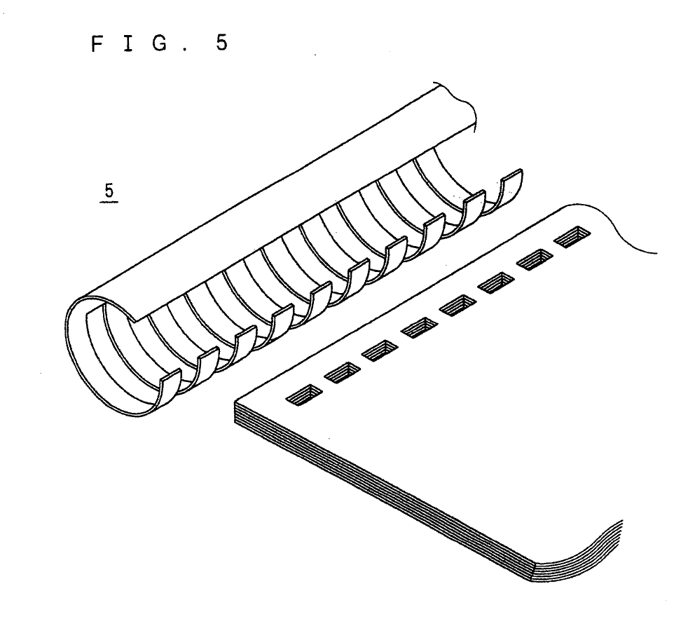

The linking paper member 5 is then inserted into the rectangular holes 4. The linking paper member 5 is formed in advance to assume a ring-like shape from the state with the comb-like shape shown in FIG. 3. More specifically, first, an impregnated state of the linking paper member 5 is obtained by immersing it into water (referred to hereinbelow as “treatment water”) with granular sugar dissolved therein. Then, the linking paper member is wound in the impregnated state thereof around the auxiliary member (for example, a cylindrical core rod), curved, and dried in this state. Further, the immersion time into the treatment water is preferably from 1.5 min or more to 15 min or less. This is because if the immersion time is less than 1.5 min, the impregnation is insufficient and the ring-like shape is difficult to form. On the other hand, if the immersion is conducted for more than 15 min, for example, in case of a laminated paper, the layers tend to peel off when the laminate is wound around the auxiliary member. It is even more preferred that the immersion time be 2 min or more to 10 min or less. Furthermore, in the present working example, the temperature of the treatment water was from 10° C. or more to 30° C. or less to provide for more uniform impregnation of sugar into the linking paper member. In order to prevent discoloration of the linking paper member and degradation of processing efficiency, the drying is conducted at a temperature of from 30° C. or more to 60° C. or less. Further, in order to prevent embrittlement and improve the operation efficiency the process is conducted at a moisture content of from 20% or more to 40% or less. In the present working example, drying was conducted for 2 h or more under the aforementioned conditions. In a dried state, as shown in FIG. 5 and FIG. 4(a), an almost C-like cross-section is obtained and a ring-like shape that is not closed is produced. The distance between the two ends is 2 mm. A high-grade sugar may be dissolved instead of granulated sugar in the treatment water, or sugars of several types may be dissolved. Furthermore, a surfactant may be added to the treatment water. A curing agent may be also introduced together with a surfactant to provide the linking paper member 5 with appropriate elasticity. As a result, a paper ring can be formed that has hardness and elastic properties corresponding to those of resin-impregnated ring.

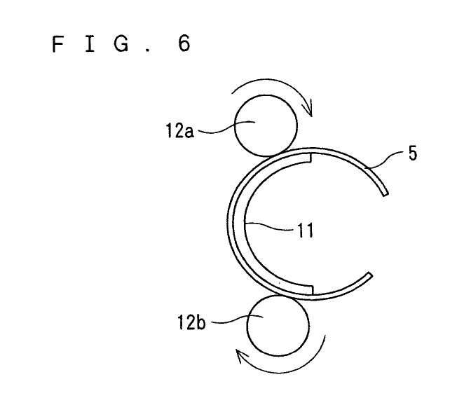

The linking paper member 5 formed in the above-described manner to have an almost C-like cross section is positioned so as to face the rectangular holes 4 in the calendar cover 1 and calendar body 2, and the linking paper member 5 is then rotated to insert the distal ends of the protruding portions 9 into the rectangular holes 4 (FIG. 4(a)). The insertion operation is conducted automatically. As shown in FIG. 6, this operation is conducted by using a guiding member 11 disposed on the left and right end side and supporting the ring-like linking paper member 5 from inside and rotary members 12a, 12b for applying light pressure from the outside of the linking paper member 5 toward the guiding member 11. It goes without saying that the rotary members 12a, 12b rotate synchronously at both ends of the linking paper member 5. The guiding member 11 may have a portion along the C-shaped linking paper member 5, but it can be effective if at least part thereof has a cylindrical shape, as shown in the figure.

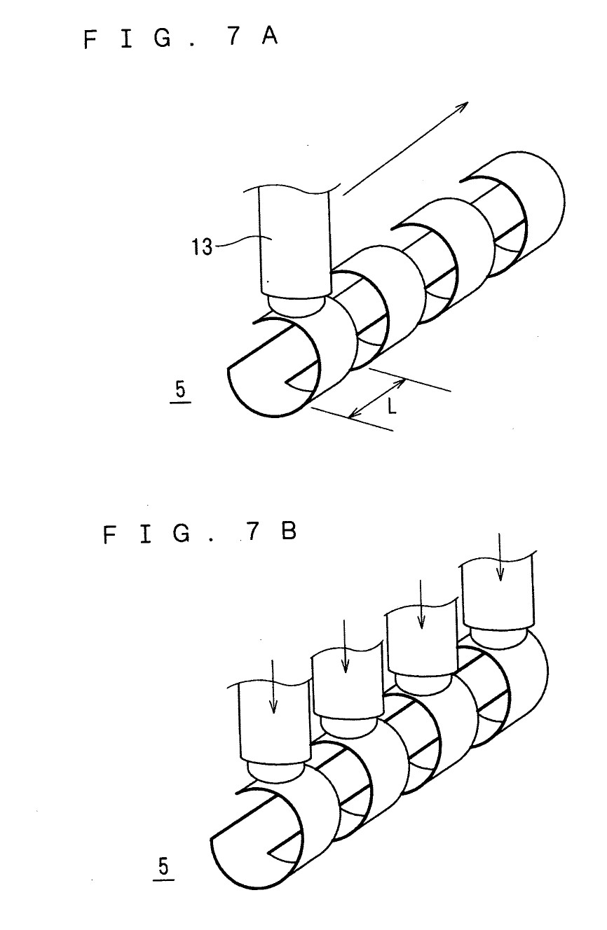

If the linking paper member 5 is rotated through the prescribed angle from the state shown in FIG. 5 and then stopped, it makes a transition from a state shown in FIG. 4(a) to a state shown in FIG. 4(b). Here, in the state shown in FIG. 4(b), an adhesive material is intermittently discharged from an adhesive bonding nozzle 13 and the adhesive material is placed on the protruding portions 9 of the linking paper member 5. More specifically, the nozzle 13 for application is temporarily stopped, as shown in FIG. 7(a), with a pitch (=L) of the protruding portions 9 in the lengthwise direction of the linking paper member 5 and discharges the adhesive material. Further, as shown in FIG. 7(b), the adhesive material may be also discharged by lowering simultaneously a plurality of adhesively bonding nozzles disposed accordingly to the pitch of the protruding portions 9. A vinyl acetate resin, an epoxy resin, and an acrylic resin can be used as the adhesive.

In the present working example, such an application operation is used. Therefore, the adhesive material is prevented from adhering to other portions of the linking paper member 5. If the adhesive material sags on other portions of the linking paper member 5, then the adjacent sheets of the calendar body will be adhesively bonded to each other and the calendar body 2 will be impossible to tear off.

After the adhesive material has been disposed on the distal ends of the protruding portions 9 in the above-described manner, the linking paper member 5 is further rotated and makes a transition from the state shown in FIG. 4(b) to the state shown in FIG. 4(c). In this state, the lower portion of the linking paper member 5 is held with a fixing jig 14, a pressure plate 15 is lowered from above, a pressure is applied to the protruding portions 9, and then a pressure is applied to the base portion 8 by pushing out a pressure plate 16 (FIG. 4(C)). In the present working example, the temperature during pressure treatment is 20° C. or higher to 40° C. or lower and moisture is 20% or higher to 60% or lower. Further, because the linking paper member 5 has an appropriate elasticity sufficient to return it to the initial state, the protruding portions 9 and base portion 8 are reliably adhesively bonded by applying pressure for the prescribed time (for example, 45 sec) with the pressure plate 16. Furthermore, in the present working example, the adhesive material was disposed on the protruding portions, but it may be also continuously disposed on the distal end of the base portion, for example, by using the conventional dispenser. Sometimes, for certain properties of adhesive material and adhesive bonding conditions, this method provides for better operability.

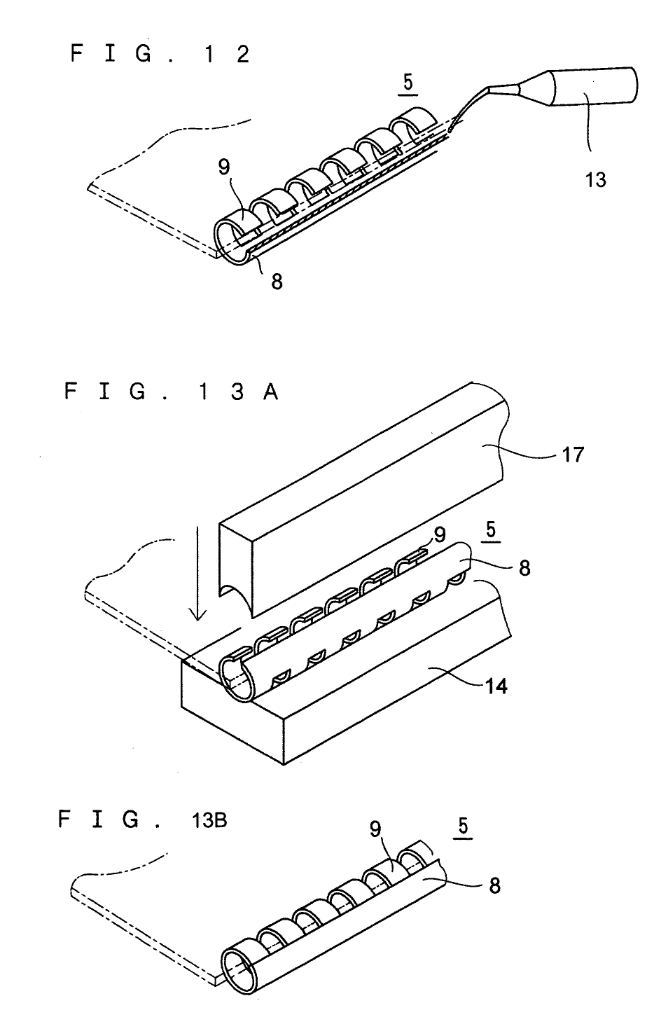

The working example in which adhesive bonding is conducted by the method different from that of the method shown in FIG. 4 will be described below in detail based on FIG. 12 and FIG. 13. In this case, the treatment preceding the insertion of the linking paper member into the rectangular holes 4 of the calendar cover 1 and calendar body 2 is identical to that of FIG. 5 and FIG. 6.

If the linking paper member 5 is rotated through the prescribed angle from the state shown in FIG. 5 and then temporarily stopped, it makes a transition to the state shown in FIG. 12. Here, as shown in FIG. 12, the adhesive material is continuously discharged from the application nozzle 14 and the adhesive material is placed on the distal end surface of the base portion 8 of the linking paper member 5. The adhesive material is applied so as to cover the entire surface on the distal end surface by using the conventional dispenser for resins. Continuous discharge is used to improve operability. If the properties of the adhesive material and adhesive bonding conditions are appropriately selected, then the adhesive material on the regions without adhesive bonding rapidly looses its adhesive properties. Therefore, no adverse effect is provided on the final molded product. Furthermore, similarly to the above-described process, a vinyl acetate resin, an epoxy resin, or an acrylic resin can be used as the adhesive material.

Once the adhesive material has been disposed on the distal end surface of the base portion in the above-described manner, the linking paper member 5 is rotated in reverse and makes a transition from the state shown in FIG. 12 to the state shown in FIG. 13(a). In this state, the lower portion of the linking paper member 5 is held with the fixing jig 14. A pressure plate 17 having the pressure surface with a curvature substantially identical to that of the outer peripheral shape of the linking paper member in a state after adhesive bonding is lowered down from above. As a result, the aforementioned pressure surface plays the role of a guide and adhesive bonding is so conducted that the distal ends of the protruding portions of the linking paper member and the opposing distal end of the base portion are adhesively bonded so that the respective end surfaces in the thickness direction face each other. Further, because the linking paper member 5 has an appropriate elasticity sufficient to return it to the initial state, the protruding portions 9 and base portion 8 are reliably adhesively bonded by applying pressure for the prescribed time (for example, 45 sec) with the pressure plate 17 (FIG. 13(b)). In the present working example, the temperature during pressure treatment is 20° C. or higher to 40° C. or lower and moisture is 20% or higher to 60% or lower.

As described hereinabove, all the operations in the manufacture of the calendar shown in FIG. 1 are implemented mechanically. Therefore, expenses on manual labor can be reduced and the production cost can be suppressed. Further, because all the components are manufactured from paper, the material cost can be reduced. Moreover, waste processing is facilitated. Thus, because no metal components are used, the risk of getting hurt during waste disposal is eliminated. Since no plastic parts are present, the waste can be safely incinerated.

If the linking paper member 5 formed to have an almost C-like shape is provided (see FIG. 5), the manufacturing process shown in FIG. 2(a) to 2(c) and FIG. 4(a) to FIG. 4(c) can be implemented with a simple manufacturing apparatus. Therefore, the calendar can be manufactured even in a small-scale company.

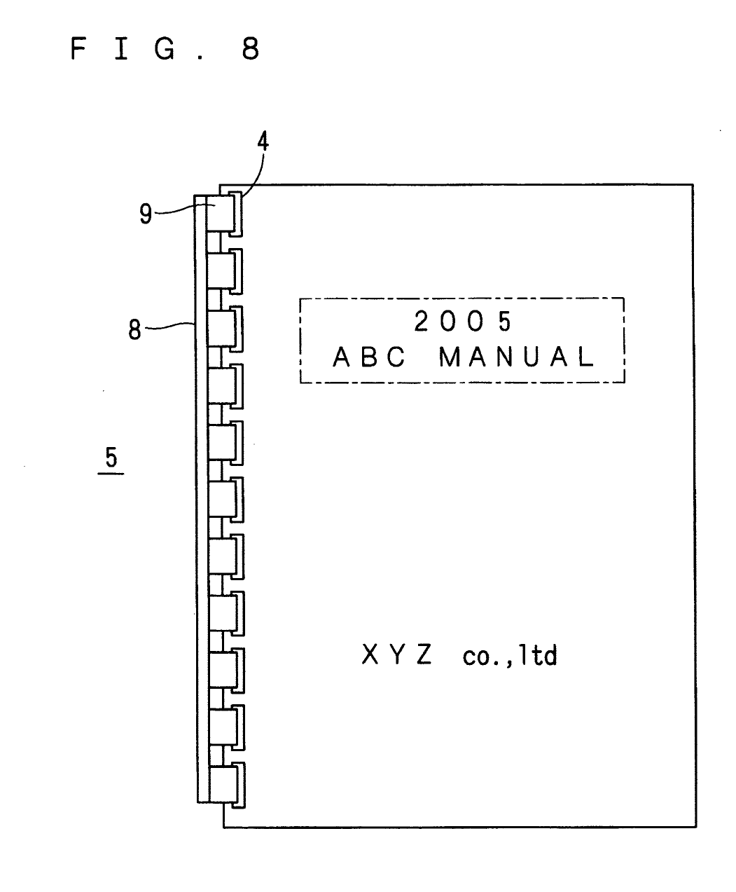

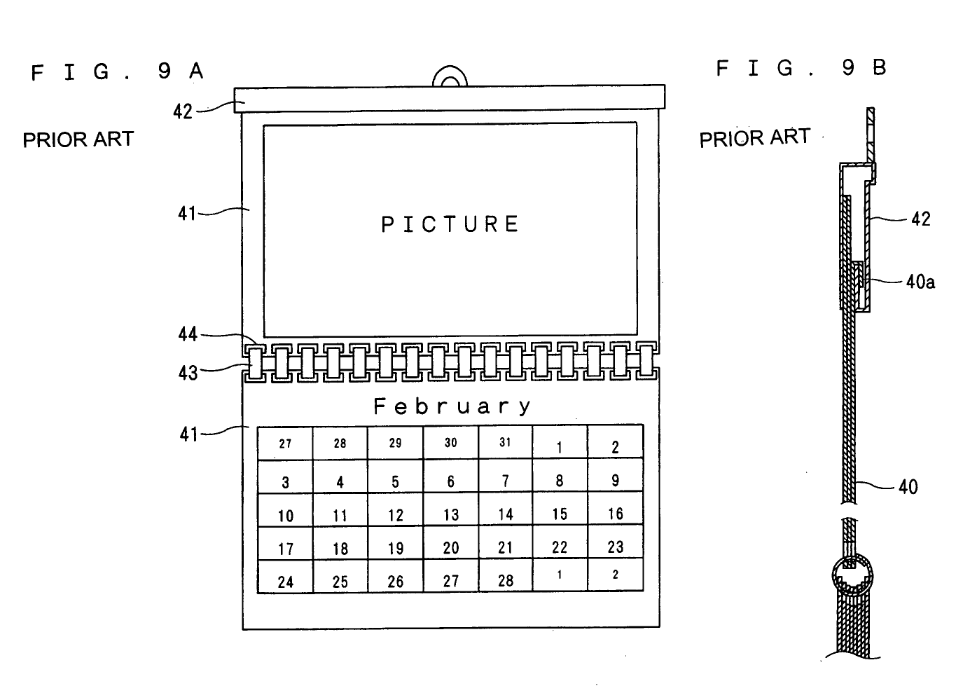

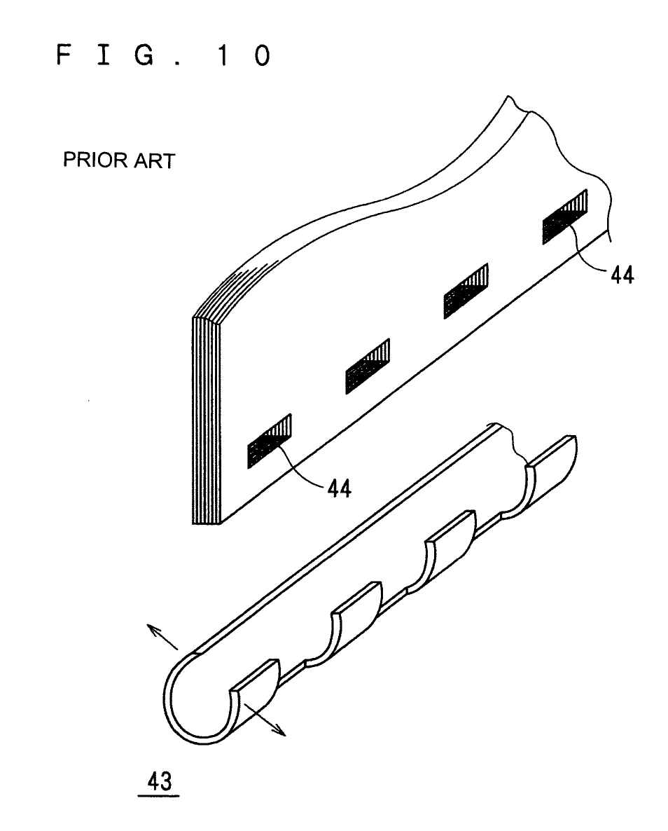

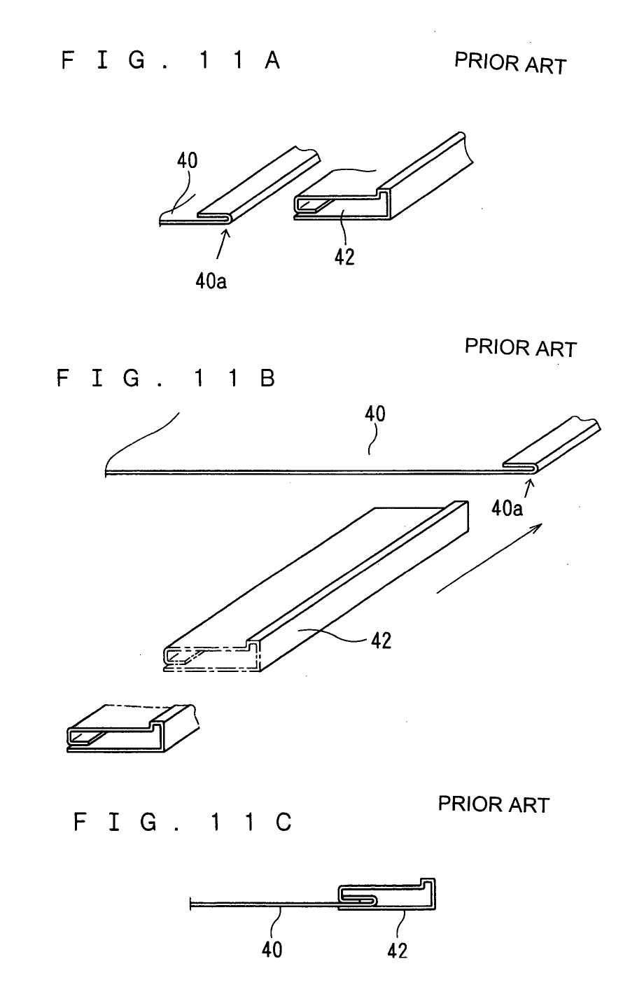

With the manufacturing apparatus capable of implementing the manufacturing process shown in FIG. 4(a) to FIG. 4(c) or FIG. 12 and FIG. 13(a), internal manuals that are manufactured in small quantities in various companies can be also manufactured in an easy manner. FIG. 8 illustrates the second working example in which the present invention is applied to a manual. In this working example, too, the linking paper member 5 is inserted into the rectangular holes 4 formed in each page and then the protruding portions 9 and base portion are adhesively bonded together to bundle the parts. The production apparatus used herein may implement the production process shown in FIG. 4(a) to FIG. 4(c) or FIG. 12 and FIG. 13(a). Therefore, it is useful for a variety of enterprises.

With the manual shown in FIG. 8, each page can be easily copied. Moreover, because the base portion 8 of the linking paper member 5 is formed from paper, the appropriate text such as the year of usage can be written therein, which is very convenient in terms of storage or picking the calendar up on some other day. Furthermore, when only specific pages of the manual are replaced, the linking paper member 5 may be cut with scissors and then manufactured. On the other hand, when the usage of the linking paper member 5 is managed in general-affair departments or the like, the sealing function of the printed material can be also realized with a sequence of page numbers of the data or the name of the responsible person inscribed on the linking paper member 5.

Further, the embodiment of the present invention was described below in details, but the above-described embodiment is merely an example for realizing the present invention. For example, FIG. 8 illustrates a manual, but individual private documents can be also manufactured in a simple manner by employing the present invention, for example, in a convenience store capable of realizing the manufacturing process illustrated by FIG. 4(a) to FIG. 4(c) or FIG. 12 to FIG. 13(a). Thus, self-produced documents can be individually manufactured by forming through holes in the document brought by a person and then mounting the linking paper member. Therefore, the present invention is not limited to the above-described embodiment and can be implemented by appropriately changing the above-described implementation mode, without departing from the essence of the present invention.

Because the linking paper member 5 and fixing paper member 3 are manufactured only from paper, they can also demonstrate an aroma-therapeutic effect upon impregnation, for example, with a perfume.

As described hereinabove, the present invention makes it possible to realize a paper ring which is produced entirely from paper and, therefore, does not discharge toxic substances during waste treatment, produces no adverse effect on environment, and can be manufactured mechanically without manual operation, and also to realize a calendar or printed material using such a ring.

1. A paper ring, which is a linking paper member of a comb-like shape impregnated at least with a sugar and composed of protruding portions and a base portion in an expanded state, wherein
the linking paper member is formed into a cylindrical shape having a central axis defined by the direction parallel to the direction along which the comb teeth are arranged; and
the end portions of said linking paper member are not adhesively joined.

2. The paper ring according to claim 1, wherein said sugar is sucrose.

3. The paper ring according to claim 1, wherein the distance between the distal ends of the protruding portion and the distal end of the opposing base portion in the cylindrical linking paper member is not less than 1 mm and no more than 3 mm.

4. A printed material comprising:
a paper ring which is impregnated at least with a sugar and in which the distal ends of protruding portions and the distal end of the opposing base portion in a cylindrical linking paper member of a comb-like shape in an expanded state are adhesively bonded; and
a plurality of paper sheets provided with through holes into which the protruding portions of said linking paper member are inserted, and which can move, while being guided by said protruding portions, after adhesive bonding.

5. A calendar comprising:
a paper ring which is impregnated at least with a sugar and in which the distal ends of protruding portions and the distal end of the opposing base portion in a cylindrical linking paper member of a comb-like shape in an expanded state are adhesively bonded; and
a plurality of paper sheets provided at one end side thereof with through holes into which the protruding portions of said linking paper member are inserted and which can move, while being guided by said protruding portions, after adhesive bonding, wherein
the said plurality of paper sheets include one calendar cover sheet and a plurality of calendar body sheets.

6. The calendar according to claim 5, wherein
a fixing paper member of a U-like cross-section is adhesively bonded on the other end side of the calendar cover of said a plurality of paper sheet; and
a gap capable of accommodating the lower end portion of calendar body sheets is formed between said fixing paper member and the calendar cover.

7. The paper ring according to claim 4, wherein said sugar is sucrose.

8. The printed material or calendar according to claim 4, wherein the distal end of the protruding portions and the distal end of the opposing base portion in said linking paper member are adhesively bonded to overlap with each other.

9. The printed material or calendar according claim 4, wherein the distal end of the protruding portions and the distal end of the opposing base portion in said linking paper member are adhesively bonded such that the end surfaces thereof in their thickness directions face each other.

10. The printed material or calendar according to claim 4, wherein said through holes are rectangular holes.

11. A method for the manufacture of a paper ring, comprising the steps of
impregnating at least a sugar into a linking paper member of a comb-like shape composed of protruding portions and a base portion in an expanded state; and then
forming the linking paper member by drying, while retaining a cylindrical shape having a central axis defined by the direction parallel to the direction along which the comb teeth are arranged.

12. A method for the manufacture of a printed material, comprising the steps of:
forming through holes on one end side of a plurality of paper sheets;
impregnating at least a sugar into a linking paper member which has a comb-like shape composed of protruding portions and a base portion in an expanded state;
drying the linking paper member, while retaining a cylindrical shape a cylindrical shape having a central axis defined by the direction parallel to the direction along which the comb teeth are arranged; and thereafter
inserting the protruding portions of said linking paper member into said through holes; and
then adhesively bonding the distal ends of the protruding portions and distal ends of the opposing base portion in said linking paper member to form a cylindrical shape.

13. A method for the manufacture of a calendar, comprising the steps of:
forming through holes on one end side of a plurality of paper sheets;
impregnating at least a sugar into a linking paper member which has a comb-like shape composed of protruding portions and a base portion in an expanded state;
drying the linking paper member, while retaining a cylindrical shape having a central axis defined by the direction parallel to the direction along which the comb teeth are arranged;
inserting the protruding portions of said linking paper member into said through holes; and
then adhesively bonding the distal ends of the protruding portions and distal ends of the opposing base portion in said linking paper member to form a cylindrical shape.

14. The manufacturing method according to claim 11, wherein said sugar is sucrose.

15. The manufacturing method according to claim 12, wherein the operation of insertion into said through holes is implemented by rotating the linking paper member along the guiding member at least part of which has a cylindrical shape.

16. The manufacturing method according to claim 12, wherein
the operation of adhesively bonding said linking paper member comprises the steps of:
disposing an adhesive material intermittently or continuously on the outer surface on one end side of said linking paper member; and
pushing down the coated surface where the adhesive material was disposed, and placing and pressing the other end side of said linking paper member on and against the coated surface which has been pushed down.

17. The manufacturing method according to claim 12, wherein
the operation of adhesively bonding said linking paper member comprises the steps of:
disposing an adhesive material continuously at least on the end surface in the thickness direction of the distal end of the base portion of said linking paper member; and
then adhesively bonding the distal ends of the producing portions and the distal end of the opposing base portion of said linking paper member so that the respective end surfaces in the thickness direction face each other.

18. The calendar according to claim 5, wherein said sugar is sucrose.

19. The calendar according to claim 5, wherein the distal end of the protruding portions and the distal end of the opposing base portion in said linking paper member are adhesively bonded to overlap with each other.

20. The calendar according to claim 5, wherein the distal end of the protruding portions and the distal end of the opposing base portion in said linking paper member are adhesively bonded such that the end surfaces thereof in their thickness directions face each other.

21. The calendar according to claim 5, wherein said through holes are rectangular holes.

22. The manufacturing method according to claim 12, wherein said sugar is sucrose.

23. The manufacturing method according to claim 13, wherein said sugar is sucrose.

24. The manufacturing method according to claim 13, wherein the operation of insertion into said through holes is implemented by rotating the linking paper member along the guiding member at least part of which has a cylindrical shape.

25. The manufacturing method according to claim 13, wherein
the operation of adhesively bonding said linking paper member comprises the steps of:
disposing an adhesive material intermittently or continuously on the outer surface on one end side of said linking paper member; and
pushing down the coated surface where the adhesive material was disposed, and placing and pressing the other end side of said linking paper member on and against the coated surface which has been pushed down.

26. The manufacturing method according to claim 13, wherein
the operation of adhesively bonding said linking paper member comprises the steps of:
disposing an adhesive material continuously at least on the end surface in the thickness direction of the distal end of the base portion of said linking paper member; and
then adhesively bonding the distal ends of the producing portions and the distal end of the opposing base portion of said linking paper member so that the respective end surfaces in the thickness direction face each other.

27. The manufacturing method according to claim 16, wherein
the adhesive material is disposed one of intermittently or continuously.
